(19) United States
(12) Patent Application Publication
(10) Pub. No.: US 2019/0300356 A1
(43) Pub. Date: Oct. 3, 2019

(54) DEVICE, SANITARY TAP AND METHOD FOR FILLING A CONTAINER WITH A CARBONATED LIQUID

(71) Applicant: Grohe AG, Hemer (DE)

(72) Inventor: Alisha BOCKHOLT, Balve (DE)

(73) Assignee: Grohe AG, Hemer (DE)

(21) Appl. No.: 16/370,120

(22) Filed: Mar. 29, 2019

(30) Foreign Application Priority Data
Mar. 29, 2018 (DE) 10 2018 107 605.3

(51) Int. Cl. B67D 1/08

(52) U.S. Cl. CPC B67D 1/0884; B67D 2001/0093

(57) ABSTRACT

A device for filling a container with a carbonated liquid. The device includes a container port for connecting the container to the device, at least one liquid line via which the carbonated liquid can be conducted from a liquid source to the container, and at least one pressure relief valve with which a target pressure in the liquid line is adjustable when filling the container. In addition, a sanitary tap with a corresponding device and a method of filling a container with a carbonated liquid is provided.

This nonprovisional application claims priority under 35 U.S.C. § 119(a) to German Patent Application No. 10 2018 107 605.3, which was filed in Germany on Mar. 29, 2018, and which is herein incorporated by reference.

### BACKGROUND OF THE INVENTION

### Field of the Invention

The present invention relates to a device, a sanitary tap and a method for filling a container with a carbonated liquid. In particular, the invention serves to provide carbonated beverages in containers, such as bottles.

### Description of the Background Art

Devices, sanitary taps and methods are known, by means of which (drinkable) liquids, such as tap water, are mixed under high pressure with carbon dioxide (CO2) in a carbonator tank. This so-called carbonation of liquids serves in particular to enhance a refreshing effect due to the stimulation of taste receptor cells when drinking. The carbonated liquid may then be filled into a container, such as a beverage bottle. For this purpose, the carbonated liquid is supplied from the carbonator tank via a liquid line to the container. When filling the container, the pressure in the liquid line and/or in the container may decrease, so that the CO2 at least partially escapes from the liquid again. It is therefore known to initially increase the pressure in the container with CO2 prior to filling with carbonated liquid in order to prevent frothing of the carbonated liquid and/or escape of the CO2 during the subsequent filling of the container with carbonated liquid. The disadvantage here, however, is the high consumption of CO2. Further, a constriction may be formed in the liquid line to increase the pressure in the liquid line upstream of the constriction by the flow resistance generated during the filling of the container. But this is not sufficient to ensure a high CO2 content in the carbonated liquid after filling into the container.

### SUMMARY OF THE INVENTION

It is therefore an object of the present invention to at least partially solve the problems described with reference to the prior art, and in particular to provide a device, a sanitary tap and a method for filling a container with a carbonated liquid with which a high CO2 content in the carbonated liquid is achieved with low CO2 consumption.

A device for filling a container with a carbonated liquid contributes to this purpose, comprising at least the following components: a container port for connecting the container to the device, at least one liquid line via which the carbonated liquid can be conducted from a liquid source into the container, and at least one pressure relief valve, with which a target pressure in the liquid line is adjustable during filling of the container.

The device can be, for example, a dispensing device, such as a sanitary tap, an outlet for such a dispensing device or an adapter that can be connected to such a dispensing device. Such sanitary taps serve in particular the demand-oriented provision of a mixed water at a tap, a kitchen sink, a bathroom sink, a shower and/or a bathtub. For this purpose, the sanitary tap is regularly fed a cold water with a cold-water temperature and a hot water with a hot-water temperature. The cold-water temperature is in particular at most 25° C. (Celsius), preferably 1° C. to 25° C., more preferably 5° C. to 20° C. and/or the hot water temperature in particular at most 90° C., preferably 25° C. to 90° C., particularly preferred 55° C. to 65° C. By means of the sanitary tap, for example by means of a mixing valve or a thermostatic cartridge, the cold water and the hot water are then miscible to a mixed water with a desired mixed water temperature. In addition, with the proposed sanitary tap or the device, a container, such as a beverage bottle, a carafe or a drinking vessel, can be filled with a carbonated liquid.

To this end, the device has a container port for connecting the container to the device. By means of the container port, the container can in particular be detachably fastened to the device. For this purpose, the container port can, for example, be designed in the manner of a quarter-turn fastener, a screw cap, a snap lock or a clamping fastener. Furthermore, a seal may be provided in the region of the container port, so that the container can be connected to the device in a liquid-tight and/or gas-tight manner. This allows for the device and the container to form a closed system. Alternatively, the container port can also be designed in the manner of an outlet opening of the dispensing device or sanitary tap, from which the carbonated liquid can flow from the dispensing device or the sanitary tap into the container. Thus, the container need not necessarily be attachable to the container port, but instead is only positionable relative to the container port such that the carbonated liquid can flow into the container through the container port. This means in particular that the container can be positioned or held, for example by a user, at a distance relative to the container port, such that the carbonated liquid can flow out of the container port into the container through a free space.

Furthermore, the device comprises at least one liquid line, via which the carbonated liquid can be conducted from a liquid source into the container. The liquid source can be, for example, a container for the carbonated liquid or a carbonator for carbonating a liquid, for example in the manner of a carbonator tank. Using the carbonator, the liquid is fed under high pressure in particular CO2, so that the CO2 is dissolved in the liquid. The at least one liquid line preferably extends from the liquid source through the container port into the container. Alternatively, the at least one liquid line can extend from the liquid source to the outlet opening of the dispensing device or sanitary tap.

In addition, the device has at least one pressure relief valve, with which a target pressure is adjustable in the liquid line when the container is being filled. For this purpose, the at least one pressure relief valve can be at least partially closed, as long as the line pressure in the liquid line is less than the target pressure. The at least one pressure relief valve may be disposed in the liquid line and/or in a vent line for venting the container. Furthermore, the at least one pressure relief valve may have a closing element loaded with a spring force, wherein the spring force is adapted and/or (variably) adaptable to the desired target pressure. The target pressure may be, for example, 1 bar to 20 bar, preferably 1 bar to 8 bar. Alternatively, the pressure relief valve can also be controlled electronically. For this purpose, the line pressure in the at least one liquid line can be measurable, for example, by means of a pressure sensor, wherein the pressure sensor is connected to a control in terms of data. When the target pressure is reached, the controller at least partially opens the at least one pressure relief valve so that the target pressure in the at least one liquid line is essentially maintained. Before filling the container, the ambient pressure in the container in particular is, for example, approximately 1 bar. At the beginning of a filling process, the pressure in the liquid line increases due to the (static) pressure in the liquid source, i.e., the opening of a valve of the liquid source and/or due to pumping the carbonated liquid through the liquid line with a pump. Upon reaching the target pressure, the at least one pressure relief valve can at least partially open. If the at least one pressure relief valve is disposed in the liquid line, the liquid line is at least partially opened up by the at least one pressure relief valve upon reaching the target pressure, such that the carbonated liquid can flow through the liquid line to the container and/or the line pressure in the liquid line does not exceed a maximum permissible pressure. If the at least one pressure relief valve is arranged in the vent line, the carbonated liquid flows through the liquid line to the container such that due to compression of the air in the container and/or at least partial degassing of the carbonated liquid in the container, the pressure in the liquid line and the container rises until the pressure reaches the target pressure. Upon reaching the target pressure, the at least one pressure valve opens at least partially, so that the pressure in the liquid line and/or in the container does not rise above a maximum allowable pressure. In particular, the closing element of the at least one pressure relief valve yields when the target pressure is reached, so that the liquid line and/or the vent line is at least partially opened up. If the line pressure in the liquid line and/or the pressure in the container while filling the container or after filling the container falls below the target pressure, the at least one relief valve closes at least partially, so that the line pressure in the liquid line or the pressure in the container is maintained or again rises to the target pressure. With the at least one pressure relief valve, the line pressure in the liquid line and/or the pressure in the container when filling the container with the carbonated liquid can be in particular (substantially) kept constant. Thus, it can be ensured with the at least one pressure relief valve that the line pressure in the liquid line and/or the pressure in the container when filling the container with the carbonated liquid substantially corresponds to the target pressure, so that degassing of the carbonated liquid can be prevented. The carbonated liquid can thus be filled into the container with low CO2 consumption and high CO2 concentration. After the container has been filled, the container can be removed or detached from the container port and can be used, for example, as a carafe.

The at least one pressure relief valve may include a closing element that is acted upon by a spring element with a closing force in such a way that the at least one pressure relief valve opens at a target pressure which is lower than the pressure in the liquid source. In this way, it can be ensured that the pressure in the liquid source is sufficient to open the at least one pressure relief valve.

The target pressure may be at least 0.1 bar lower than the pressure in the liquid source. In particular, the target pressure may be 0.5 to 1 bar lower than the pressure in the liquid source. This can ensure that the flow through the liquid line is not too high, so that turbulence of the carbonated liquid can be prevented.

The at least one pressure relief valve may be arranged in a vent line of the container. The vent line in particular connects a receiving space of the container for the carbonated liquid to the environment of the device. For this purpose, the vent line preferably extends from the receiving space of the container through the container port to the environment of the device. Through the vent line, air and/or CO2 from the receiving space can be conducted into the environment or atmosphere. If the device is designed in the manner of an adapter, the vent line may be partly formed in the adapter and partly in the dispensing device. In this case, the at least one pressure relief valve can be arranged in the adapter or in the dispensing device.

Furthermore, the at least one pressure relief valve may be arranged in the liquid line. In particular, the at least one pressure relief valve is arranged at one end of the liquid line, with which the liquid line opens into the container or the outlet opening of the dispensing device or sanitary tap. Preferably, the at least one pressure relief valve is arranged along the liquid line at most 10 cm (centimeters) upstream of the end of the liquid line or the outlet opening in the liquid line.

The at least one pressure relief valve may close when the line pressure in the liquid line is lower than the target pressure.

The at least one pressure relief valve can open when the line pressure in the liquid line reaches the target pressure.

According to another aspect of the invention, also provided is a sanitary tap which has at least the following components: a valve body with an outlet, a liquid source for a carbonated liquid, and a device proposed here.

With regard to the details of the sanitary tap, reference is made to the description of the device.

In accordance with yet another aspect of the invention, also provided is a method of filling a container with a carbonated liquid, comprising at least the following steps: the provision of the carbonated liquid in a liquid source; the filling of the container with the carbonated liquid from the liquid source via at least one liquid line, and the setting of a target pressure in the liquid line using at least one pressure relief valve.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a sanitary tap with an embodiment of a device;

FIG. 2 is an embodiment of a device in a side view; and

FIG. 3 is the device in a sectional view.

### DETAILED DESCRIPTION

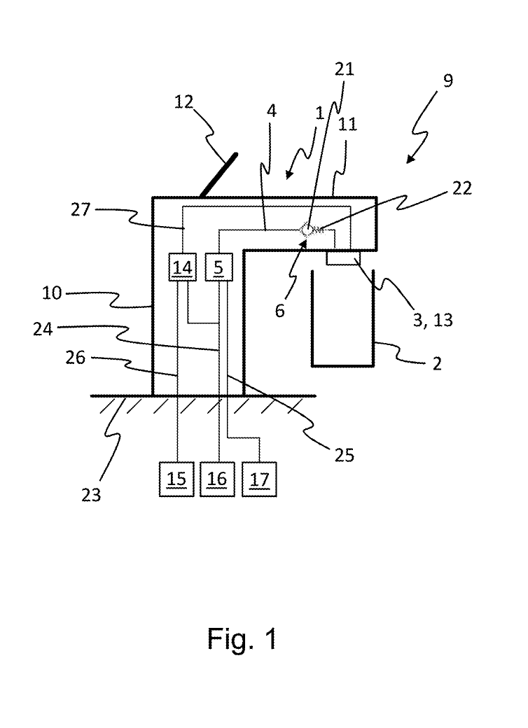

FIG. 1 shows a sanitary tap 9 with a first embodiment of a device 1 in a schematic representation. The sanitary tap 9 has a valve body 10 with which the sanitary tap 9 is attached to a support 23, which in the present case is a working surface. Further, the sanitary tap 9 includes a mixing valve 14 to which cold water can be supplied from a cold-water source 16 and hot water can be supplied from a hot-water source 15 via a hot water line 26. By means of the mixing valve 14, the cold water and the hot water is miscible to a mixed water with a desired mixed water temperature. The mixed water temperature is adjustable via a lever 12 by a user of the sanitary tap 9. The mixed water can be conducted from the mixing valve 14 via a mixed water line 27 through an outlet 11 of the valve body 10 to an outlet opening 13 of the sanitary tap 9. Furthermore, the sanitary tap 9 comprises the device 1, which includes a liquid source 5. The liquid source 5 is formed here in the manner of a carbonator tank. The liquid source 5 can be fed cold water via the cold-water line 24 from the cold-water source 16 and CO2 via a CO2 line 25 from a CO2 source 17, which in this case is a pressurized tank. The cold water can be enriched with CO2 by the liquid source 5 under pressure and passed as a carbonated liquid via a liquid line 4 through the outlet 11 of the valve body 10 to a container port 3, which here is formed as the outlet opening 13, and through which the carbonated liquid can be filled into a container 2. Also arranged in the liquid line 4 is a pressure relief valve 6, which comprises a closing element 21 for at least partially closing the liquid line 4, and a spring element 22, with which the closing element 21 can be acted upon by a closing force. When starting a filling process, the carbonated liquid is provided, i.e., produced in the liquid source 5. After opening a valve, not shown here, the carbonated liquid flows from the liquid source 5 through the liquid line 4 in the direction of the pressure relief valve 6. This increases the line pressure in the liquid line 4 until reaching a target pressure at which the closing force of the spring element 21 of the pressure relief valve 6 is overcome, so that the closing element 21 of the pressure relief valve 6 at least partially opens up the liquid line 4. After the (automatic) opening of the pressure relief valve 6 upon reaching the target pressure in the liquid line 4, the carbonated liquid flows further via the liquid line 4 in the direction of the outlet opening 13, through which the carbonated liquid flows to the container 2. By means of the pressure relief valve 6, the line pressure in the liquid line 4 is set substantially constant to the target pressure while the container is being filled.

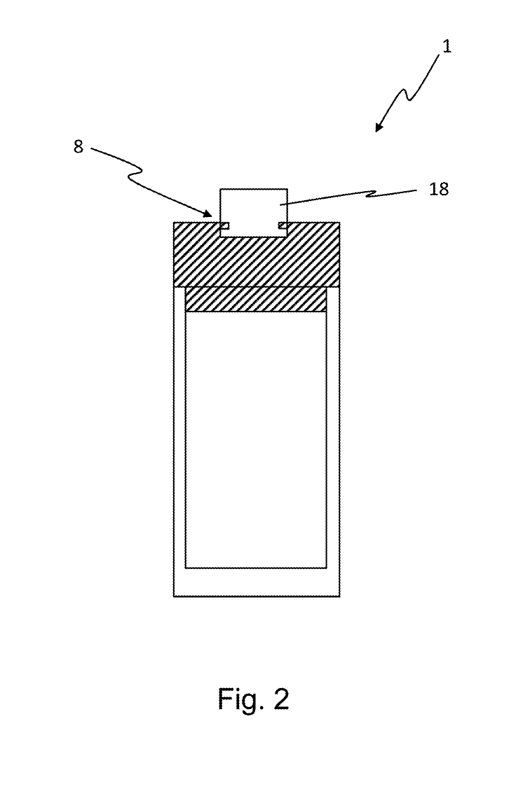

FIG. 2 shows a second embodiment of a device 1 in a side view. The device 1 has a connecting means 8, which is designed here in the manner of a quarter-turn fastener. By means of the connecting means 8, the device 1 is releasably attachable to a dispensing device or sanitary tap 9, not shown here. In particular, the device 1 with the connecting means 8 can be fastened to a mousseur 18, which is arranged, for example, on or in an outlet opening 13 of the sanitary tap 9. The second embodiment of the device 1 is thus formed in the manner of an adapter, which can be fastened via the connector 8 to a dispensing device or sanitary tap 9.

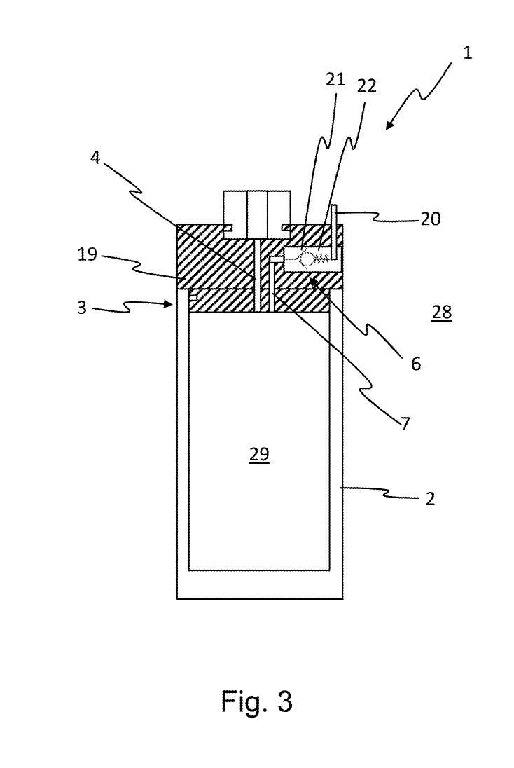

FIG. 3 shows the second embodiment of the device 1 in a sectional view. The device 1 has a housing 19, to which a container 2 can be detachably fastened via a container port 3, which is designed here in the manner of a quarter-turn fastener. Furthermore, the device 1 has a liquid line 4, via which a carbonated liquid can be conducted from a liquid source 5, not shown here, to the container 2. The liquid line 4 extends through the housing 19. In addition, the device 1 comprises a pressure relief valve 6, which is arranged in a vent line 7. The vent line 7 also extends through the housing 19 and connects a receiving space 29 of the container 2 for the carbonated liquid to the environment 28 of the device 1. When starting a filling process, initially an ambient pressure of about 1 bar prevails in the receiving space 29 of the container 2. The carbonated liquid flows via the liquid line 4 into the receiving space 29 of the container 2, whereby the pressure in the liquid line 4 and the receiving space 29 increases by compressing the air in the receiving space 29 and by at least partially outgassing the carbonated liquid in the receiving space 29. Upon reaching the target pressure in the liquid line 4 and the container 2, a closing force of a spring element 22 on a closing element 21 of the pressure relief valve 6 is overcome, so that the closing element 21 at least partially opens up the vent line 7. As a result, the air and/or the CO2 can escape from the receiving space 29 via the vent line 7 into the environment 28, so that the target pressure in the liquid line 4 and/or the receiving space 29 of the container 2 is (substantially) set constant to the target pressure. Additionally, the pressure relief valve 6 here can be manually actuated via a valve operating lever 20. The pressure relief valve 6 is formed here in the manner of a proportioning valve, which allows for a steady transition between a closed position and an open position. In this way, a sudden drop in pressure in the liquid line 4 and the receiving space 29 can be avoided, which could otherwise lead to an undesirably strong frothing of the carbonated liquid in the receiving space 29 of the container 2.

By means of the present invention, a carbonated liquid can be filled into a container with low CO2 consumption with a high concentration of CO2.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A device for filling a container with a carbonated liquid, the device comprising:
a container port for connecting the container to the device;
at least one liquid line via which the carbonated liquid is adapted to be conducted from a liquid source to the container; and
at least one pressure relief valve with which a target pressure in the liquid line is adjustable when filling the container.

2. The device according to claim 1, wherein the at least one pressure relief valve has a closing element which is acted upon by a spring element with a closing force such that the at least one pressure relief valve opens at a target pressure which is lower than the pressure in the liquid source.

3. The device according to claim 2, wherein the target pressure is at least 0.1 bar lower than the pressure in the liquid source.

4. The device according to claim 1, wherein the at least one pressure relief valve is arranged in a vent line of the container.

5. The device according to claim 1, wherein the at least one pressure relief valve is arranged in the liquid line.

6. The device according to claim 1, wherein the at least one pressure relief valve closes when the line pressure in the liquid line is lower than the target pressure.

7. The device according to claim 1, wherein the at least one pressure relief valve opens when the line pressure in the liquid line reaches the target pressure.

8. The device according to claim 1, further comprising a connector with which the device is releasably attachable to a sanitary tap.

9. A sanitary tap comprising:
a valve body with an outlet;
a liquid source for a carbonated liquid; and
a device according to claim 2.

10. A method of filling a container with a carbonated liquid, the method comprising:
providing the carbonated liquid in a liquid source;
filling the container with the carbonated liquid from the liquid source via at least one liquid line; and
setting a target pressure in the liquid line using at least one pressure relief valve.
